(19) United States
(12) Patent Application Publication
(10) Pub. No.: US 2025/0383000 A1
(43) Pub. Date: Dec. 18, 2025

(54) BRAKE PADS

(71) Applicant: Webb Wheel Products, Inc., Cullman, AL (US)

(72) Inventors: Johnathon K. Capps, Cullman, AL (US); Garrett W. Davis, Vinemont, AL (US); Trenton W. Hopper, Hayden, AL (US)

(73) Assignee: Webb Wheel Products, Inc., Cullman, AL (US)

(21) Appl. No.: 19/242,367

(22) Filed: Jun. 18, 2025

Related U.S. Application Data
(60) Provisional application No. 63/661,226, filed on Jun. 18, 2024.

(51) Int. Cl. F16D 65/847; F16D 55/225; F16D 65/092

(52) U.S. Cl. CPC F16D 65/847; F16D 65/092; F16D 55/225

(57) ABSTRACT

A brake pad for a disc brake that brakes a rotor that is rotated about a center axis includes a first side, an opposite second side longitudinally spaced apart from the first side, a first end, and an opposite second end axially spaced apart from the first end. The brake pad includes a backing plate and a friction member on the backing plate with the friction member configured to engage the rotor. A symmetrical notch extends through the backing plate and the friction member and located at the second end. The notch axially extends from the second end toward the first end. A channel axially extends through the friction member between the notch and the first end.

### CROSS-REFERENCE TO RELATED APPLICATION

The present disclosure is based on and claims priority to U.S. Provisional Patent Application No. 63/661,226 filed Jun. 18, 2024, the disclosure of which is incorporated herein by reference.

### FIELD

The present disclosure relates to brake pads, and specifically to brake pads for disc brakes.

### BACKGROUND

The following U.S. Patent Application Publication is incorporated herein by reference in entirety.

U.S. Patent Application Publication No. 2023/0417301 discloses systems and methods for monitoring a wear state of a disc brake for braking a rotor of a vehicle. The disc brake has a caliper configured to clamp opposing inner and outer brake pads onto the rotor. A primary wear sensor is configured to sense a combined thickness of the rotor, the inner brake pad, and the outer brake pad. A controller is programmed to calculate an estimated wear amount of the inner brake pad and an estimated wear amount of the outer brake pad based upon the combined thickness. In some embodiments a secondary wear sensor is included and the system is configured to calculate an actual wear amount of the inner brake pad and an actual wear amount of the outer brake pad based upon input from the primary wear sensor and the secondary wear sensor.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a brake pad for a disc brake that brakes a rotor that is rotated about a center axis includes a first side, an opposite second side longitudinally spaced apart from the first side, a first end, and an opposite second end axially spaced apart from the first end. The brake pad includes a backing plate and a friction member on the backing plate with the friction member configured to engage the rotor. A symmetrical notch extends through the backing plate and the friction member and is located at the second end. The notch axially extends from the second end toward the first end. A channel axially extends through the friction member between the notch and the first end.

In certain examples, a brake pad for a disc brake that brakes a rotor that is rotated about a center axis and the brake pad includes a first side, an opposite second side longitudinally spaced apart from the first side, a first end, and an opposite second end axially spaced apart from the first end. The brake pad includes a backing plate and a friction member on the backing plate, the friction member configured to engage the rotor. A symmetrical notch extends through the backing plate and the friction member and is located at the second end. The notch axially extends from the second end toward the first end. A symmetrical channel axially extends through the friction member and is located between the notch and the first end. The notch and the channel are centered between the first end and the second end.

In certain examples, a disc brake for braking a rotor that is rotated about a center axis includes a caliper and a brake pad coupled to the caliper. The brake pad is configured to engage the rotor to thereby slow or stop rotation of the rotor about the center axis, and the brake pad includes a first side, an opposite second side longitudinally spaced apart from the first side, a first end, and an opposite second end axially spaced apart from the first end. The brake pad includes a backing plate and a friction member on the backing plate. The friction member is configured to engage the rotor. A symmetrical notch extends through the backing plate and the friction member, is located at the second end, and the notch axially extends from the second end toward the first end. A channel axially extends through the friction member between the notch and the first end.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example disc brake according to the present disclosure for braking a rotor coupled to a wheel of a vehicle.

FIG. 2 is an exploded view of the disc brake and the rotor of FIG. 1.

FIG. 3 is a perspective view of another example rotor and example brake pads according to the present disclosure.

FIG. 4 is a side view of the rotor and the brake pad of FIG. 3.

FIG. 5 is a side view of the brake pad of FIG. 3.

FIG. 6 is a perspective end view of the brake pad of FIG. 3.

FIG. 7 is a schematic side view of an example channel of FIG. 6.

FIG. 8 is a schematic side view of another example channel according to the present disclosure.

FIG. 9 is a partial perspective view of the rotor and the brake pad of FIG. 3.

FIG. 10 is another side view of the rotor and the brake pad of FIG. 3.

FIG. 11 is an enlarged view of the rotor and the brake pad in FIG. 10 within line 10-10 on FIG. 10.

### DETAILED DESCRIPTION

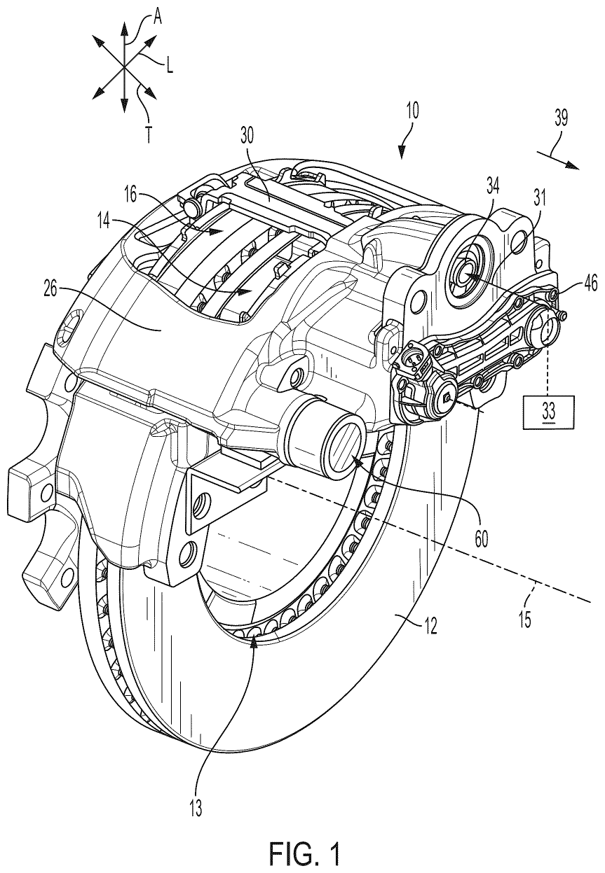

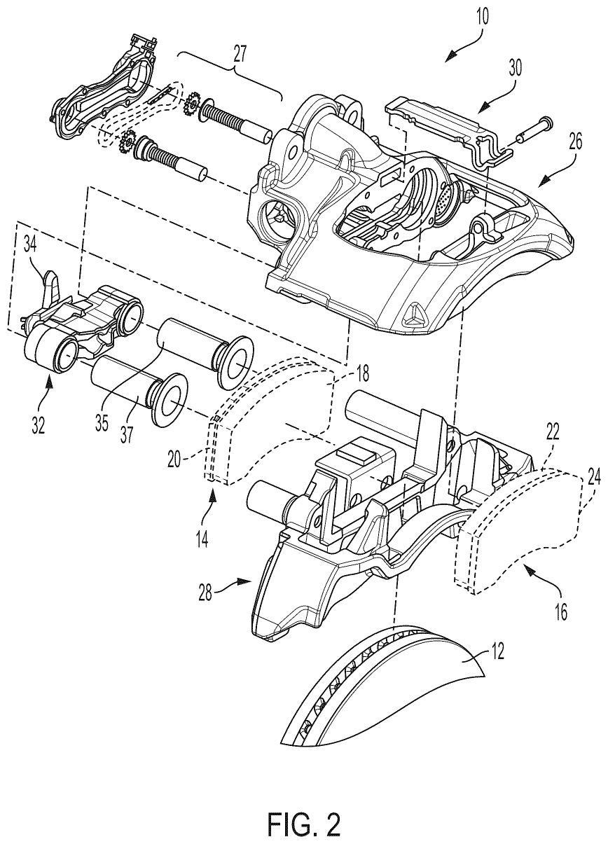

FIGS. 1-2 depict an example disc brake 10 according to the present disclosure for braking a rotor 12 coupled to the wheel of a vehicle. The rotor 12 has a center hole 13 and a center axis 15 about which the rotor 12 is rotated. The disc brake 10 is configured to clamp opposing inner and outer brake pads 14, 16 (depicted schematically in dashed lines on FIG. 2) onto opposite sides of the rotor 12, to thereby apply a braking force that stops rotation of the rotor 12 and thus stop rotation of the corresponding wheel of the vehicle. The inner brake pad 14 includes a friction member (referred to therein as an inner friction member 18) for frictionally engaging the inner side of the rotor 12 and a backing plate (referred to herein as an inner backing plate 20) that supports the inner friction member 18. The outer brake pad 16 includes a friction member (referred to herein as an outer friction member 22) for frictionally engaging the outer side of the rotor 12 and a backing plate (referred to herein as an outer backing plate 24) that supports the outer friction member 22.

The disc brake 10 further includes a caliper housing 26, a carrier 28 that contains the inner and outer brake pads 14, 16, and an adjuster 27 that automatically adjusts the position of the inner and outer brake pads 14, 16 relative to the rotor 12, for example as the inner and outer friction members 18, 22 and rotor 12 wear down. The carrier 28 is fixed to the vehicle, for example via a bracket secured to the vehicle's axle. The caliper housing 26 is slideable relative to the carrier 28, as is known in the art. A removable retainer clip 30 retains and facilitates removal and replacement of worn inner and outer brake pads 14, 16. An actuator block 32 contains an input lever 34 for actuating the disc brake 10.

The disc brake 10 is operated by depressing the brake pedal in the cab of the vehicle such that a compressed air chamber 33 on the vehicle applies an input force on an input lever 34 in a first direction (see arrow 31). This moves the inner friction member 18 axially into frictional braking engagement with the rotor 12. Braking engagement of the inner friction member 18 on the rotor 12 generates a reaction force on the caliper housing 26, which causes the caliper housing 26 to axially slide along tappets 35, 37 relative to the carrier 28, in an opposite second direction (see arrow to arrow 39). This moves the outer friction member 22 of the outer brake pad 16 into frictional braking engagement with the outer side of the rotor 12. Note that the tappets 35, 37 are slidably received into bores 36 defined in the actuator block 32.

Over time, the sides of the rotor 12 and/or the inner and outer friction members 18, 22 wear down from the frictional engagements, such that the thicknesses of these components decrease. As such, the gap between the inner and outer friction members 18, 22 and the opposite sides of the rotor 12 when the disc brake 10 is at rest increases. To account for wear, the adjuster 27 actively maintains the gap at a constant value over the wear life of the respective components by automatically adjusting the axial positions of the inner and outer brake pads 14, 16 relative to the rotor 12. In addition to and/or after the adjuster 27 can no longer maintain the gap, the brake pads 14, 16 can be replaced.

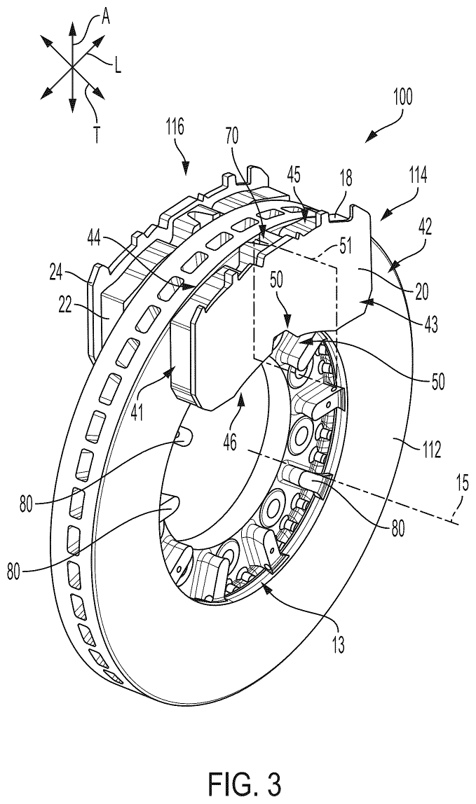

Through research and experimentation, the present inventors developed the novel example brake pads 14, 16, 114, 116 described in the present disclosure. Note that while the description provided below refers to the inner brake pad, the example outer brake pads of the present disclosure can include one or more components and/or features described with reference to the inner brake pads. Also note that each example inner brake pad of the present disclosure described herein can include any features or components of any other example inner brake described herein. Similar components and/or features of the different example inner brake pads 14, 114 may be denoted with the same part numbers. However, the use of the same part numbers for components and/or features the example inner brake pads 14, 114 of the present disclosure should not be construed to indicate that the similarly marked components and/or features are necessarily identical. Instead, the similarly marked components and/or features may have varying features or characteristics. For instance, the maximum thickness of the inner friction member 18 of FIG. 2 is different than the maximum thickness of the inner friction member 18 of FIG. 3.

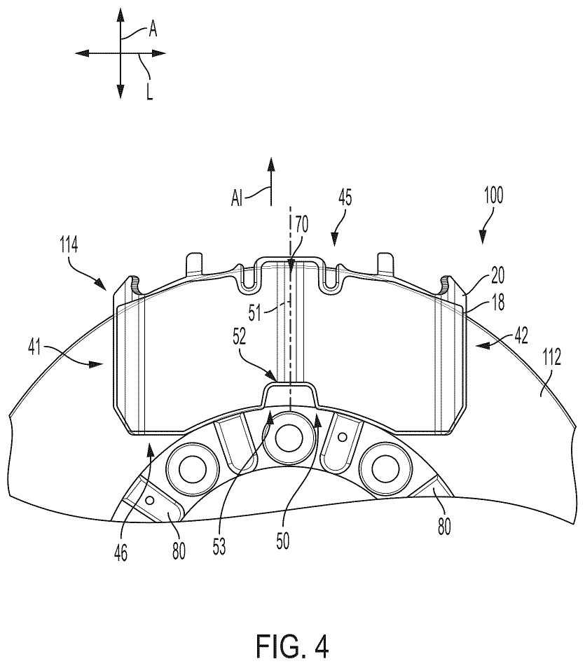

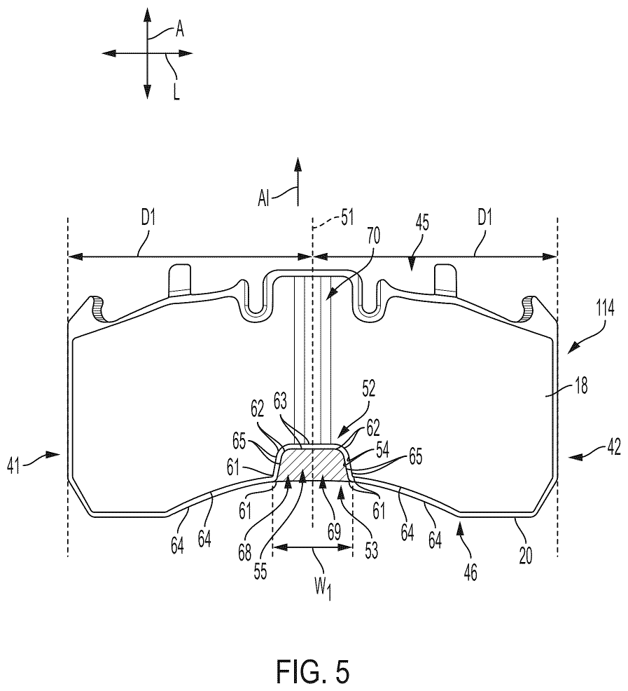

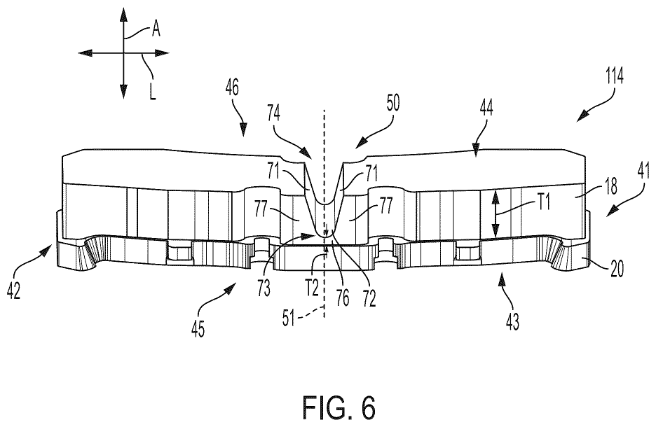

FIGS. 3-6 depict another example disc brake 100 according to the present disclosure. Note that FIG. 3 excludes certain components (e.g., retainer clip, actuator block) of the disc brake depicted in FIGS. 1-2) for clarity and to expose the example brake pads 114, 116 and the example rotor 112. FIG. 4 depicts the inner brake pad 114 as transparent to expose the rotor 112, and FIGS. 5-6 depict components and features of the inner brake pad 114 in greater detail. Further note that FIGS. 4-5 depicts the inner backing plate 20 in front of the inner friction member 18 with features of the inner friction member 18 depicted visible through the inner backing plate 20.

The inner brake pad 114 generally longitudinally extends (see example longitudinal axis L) between a longitudinal first side 41 and a longitudinal second side 42 and laterally extends (see example lateral axis T) between a first lateral face 43 and a second lateral face 44. The inner brake pad 14 also axially extends (see example axis A) between an upper first end 45 and a lower second end 46. Note that the inner brake pad 14 may be further described herein as radially extending between the first end 45 and the second end 46 given reference to the center axis 15 of the rotor 112. Note that FIG. 5 depicts the inner friction member 18 facing forward with the inner backing plate 20 supporting the inner friction member 18 thereunder.

When the inner brake pad 114 is coupled to the disc brake 100 (see FIG. 3), the inner backing plate 20 faces and is oriented away from the rotor 112 and the inner friction member 18 faces and is oriented toward the rotor 112. During braking operations, the inner friction member 18 engages the rotor 112 thereby slowing and/or stopping rotation of the rotor 112. The second end 46 is also oriented toward the center hole 13 and center axis 15 of the rotor 112.

A notch 50 extends through the inner brake pad 114 between the lateral faces 43, 44 of the inner brake pad 114 and is located at the second end 46 and extends from the second end 46 toward the first end 45. Specifically, the notch 50 extends through and is at least partially defined by the inner backing plate 20 and the inner friction member 18. A channel 70 is in the inner friction member 18, and the channel 70 axially and radially extends between the notch 50 and the first end 45 of the inner brake pad 114. The notch 50 and the channel 70 are described in greater detail below.

The notch 50 is located at the second end 46 of the inner brake pad 114, and the notch 50 extends in a first axial direction (arrow A1) from the second end 46 toward the first end 45. The first axial direction (arrow A1) is a direction from the second end 46 to the first end 45, and the first axial direction (arrow A1) extends radially away from the center axis 15 of the rotor 112. The notch 50 has an open second notch end 53 that is oriented toward the center hole 13 and center axis 15 of the rotor 112.

The notch 50 extends along and is centered on a brake pad plane 51 (represented as dashed line 51) which axially and radially extends between the ends 45, 46. The brake pad plane 51 is equidistant from the first side 41 and the second side 42 (see distances D1 on FIG. 5 each representing the distance between the brake pad plane 51 and one of the sides 41, 42). The notch 50 is shaped to be symmetrical about the brake pad plane 51. The notch 50 is centered on the brake pad plane 51. In certain examples, the notch 50 has a first notch portion 68 on one side of the brake pad plane 51 and a second notch portion 69 on the other side of the brake pad plane 51. The second notch portion 69 has a shape that mirrors the first notch portion 68. Note that in these examples, the surfaces (described further herein) of the inner friction member 18 and the inner backing plate that at least partially define the notch 50 are mirrored about the brake pad plane 51.

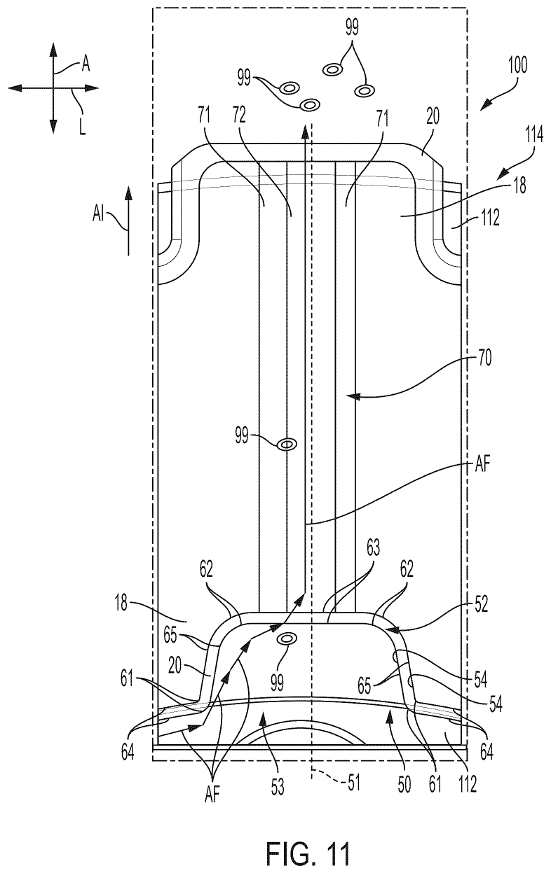

The notch 50 has a partially closed first notch end 52 oriented toward the first end 45 and an open second notch end 53 oriented toward the center hole 13 and the center axis 15. Both the inner backing plate 20 and the inner friction member 18 each have a notch surface 54 (see also FIG. 11) that define the sides 57 of the notch 50. The notch surface 54 of the inner friction member 18 are stepped or laterally offset from the notch surface 54 of the inner backing plate 20. Note that in other examples, the notch surface 54 of the inner friction member 18 and the inner backing plate 20 are flush with each other. The notch surfaces 54 of the inner friction member 18 and the backing plate 20 each include a pair of first transition sections 61 and a pair of second transition sections 62. The first transition sections 61 are located at the second end 46 adjacent to end surfaces 64 of the inner friction member 18 and the inner backing plate 20. The first transition sections 61 are curved, and in one example, the first transition section 61 has a radius of curvature of 0.09 inches.

The second transition sections 62 are located radially inwardly in the first axial direction (arrow A1) from the second end 46 where the notch surfaces 54 include center surfaces 63 extending between the second transition sections 62. The second transition sections 62 are curved, and in one example, the second transition section 62 has a radius of curvature of 0.19 inches. Side sections 65 are between the transition sections 61, 62. The notch surface 54 of the inner friction member 18 includes a pair of first transition sections 61, a pair of side sections 65, a pair of second transition sections 62, and a center surface 63, and the notch surface 54 of the inner backing plate 20 includes a pair of first transition sections 61, a pair of side sections 65, a pair of second transition sections 62, and a center surface 63.

When the inner brake pad 114 is installed on the disc brake 10, a tab or protrusion on the disc brake 10 may be received into the notch 50. The present inventors observed that certain conventional disc brakes manufactured by different manufacturers have tabs and/or protrusions with different sizes and/or shapes, and as such the present inventors developed the example inner brake pads of the present disclosure with a notch that can accommodate a variety of different tabs and/or protrusions therein when the inner brake pad is installed onto the disc brake. As such, the example brake pads of the present disclosure are capable of being installed on a variety of example disc brakes, some of which are depicted in the present disclosure.

The present inventors further discovered that the symmetrical/mirrored features of the notch 50 in the example disc brakes of the present disclosure reduces vibrations and/or noise during operation of the disc brakes of the present disclosure compared to conventional disc brakes. With some conventional disc brakes, vibrations and/or noise may be generated due to uneven loading on the conventional brake pads. The present inventor discovered that symmetrical/mirrored features of the example notches and the example brake pads of the present disclosure advantageously reduce vibrations/noise due to the brake pads and the disc brakes more generally being more balanced compared to conventional brake pads of conventional disc brakes which may include asymmetrical features. In certain examples, the notch surfaces and/or the transition sections of the example brake pads of the present disclosure advantageously funnel air through the notch and further the channel thereby decreasing noise and vibrations generated by the brake pad.

In certain examples, the width (see W1 on FIG. 5) of the second notch end 53 of the notch 50 is larger than the width of notches of conventional brake pads. In one example, the width of the second notch end 53 is 1.39 inches while the width of a notch of a conventional brake pad is 0.81 inches. The present inventors recognized that increasing the width of the second notch end 53 advantageously facilitates the notch 50 collecting air flow (described in greater detail therein below). In addition, the notch surfaces 54 preferably include curved sections and are configured to direct or funnel air flow from the second notch end 53 to the channel 70 (described further herein). In certain examples, the notch surfaces 54 are tapered inwardly toward the brake pad plane 51.

In certain example, the present inventors recognized that increasing the profile notch surface area 55 (see hatched surface area between the notch surfaces 54 of the inner backing plate 20 on FIG. 5) relative to the overall contact surface area of the inner friction member 18 (the overall contact surface area is equivalent to the surface of the inner friction member 18 that engages the rotor 12 when braking is applied) does not materially affect the braking effectiveness of the inner braking pad 14 in comparison to conventional brake pads having notches with smaller profile notch surface areas to the overall contact surface area. In certain examples, the ratio of notch surface area 55 to the overall contact surface area is greater with the example inner brake pads of the present disclosure compared to conventional brake pads. In certain examples, the profile notch surface area 55 is 0.671 square inches. In certain examples, the overall contact surface area of the inner brake pad 14 is 24.55 square inches.

The channel 70 extends along and/or is centered on the brake pad plane 51. The channel 70 is symmetric about the brake pad plane 51. The shape of the channel 70 can vary. In the example depicted in FIGS. 5-7, the channel is generally V-shaped. The inner friction member 18 includes a pair of opposing side surfaces 71 and a center surface 72 positioned between the side surfaces 71. The side surfaces 71 generally extend from the first end 45 to the second end 46 and between the notch 50 and the first end 45. The center surface 72 is curved and is rounded between the side surfaces 71. In certain examples, the center surface 72 extends along a radius of curvature in the range of 0.01-0.50 inches (note the value of the radius of curvature can be the indicated upper or lower limits of the range). In one specific example, the center surface 72 has a radius of curvature of 0.03-0.38 inches (note the value of the radius of curvature can be the indicated upper or lower limits of the range). The side surfaces 71 extend transverse to each other, and the side surfaces 71 define a channel angle 78 therebetween. The channel angle 78 can vary, and in certain examples, the channel angle 78 is a value in the range of 0.05 degrees to 45.0 degrees (note the value of the channel angle 78 can be the indicated upper or lower limits of the range). In one specific example, the channel angle 78 is a value in the range of 0.10 degrees to 40.0 degrees. (note the value of the channel angle 78 can be the indicated upper or lower limits of the range). In one specific example, the channel angle is 15.0 degrees. In other examples, the side surfaces 71 extend parallel to each other.

The center surface 72 defines a closed end 73 of the channel 70 that is opposite an open end 74 that is oriented toward the rotor 12 (see FIG. 4). The channel 70 and the notch 50 are in fluid communication with each other such that air, debris, moisture, and/or liquids may pass through the notch 50 and the channel 70. In certain examples, the channel 70 intersects the notch 50 at the partially closed first notch end 52 of the notch 50.

The inner friction member 18 has an initial or maximum thickness T1 when initially installed on the disc brake. Note that in certain examples the channel 70 does not extend to the inner backing plate 20. A center section 76 of material forming the inner friction member 18 extends between the channel 70 and the inner backing plate 20. The center section 76 extends between two adjacent sections 77 of the inner friction member 18. The center section 76 has a thickness T2 less than the maximum thickness T1.

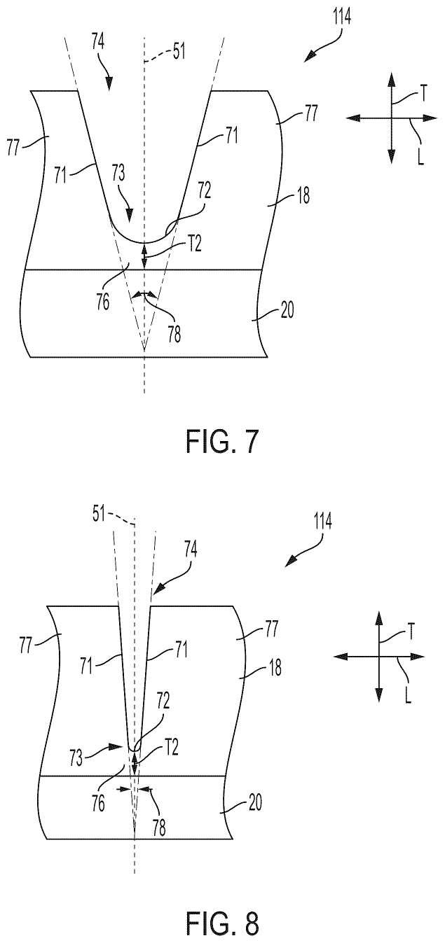

FIG. 8 is a schematic side view of another example channel 70 according to the present disclosure. The channel 70 is generally ‘V’ shaped with a more pointed center than the shape of the channel 70 depicted in FIG. 7. The center surface 72 extends along a radius of curvature of 0.03 inches. The side surfaces 71 extend transverse to each other, and the side surfaces 71 define a channel angle 78 therebetween. The channel angle 78 can vary, and in certain examples, the channel angle 78 is a value in the range of 0.1 degrees to 40.0 degrees (note the value of the channel angle 78 can be the indicated upper or lower limits of the range). In one specific example, the channel angle 78 is 5.0 degrees.

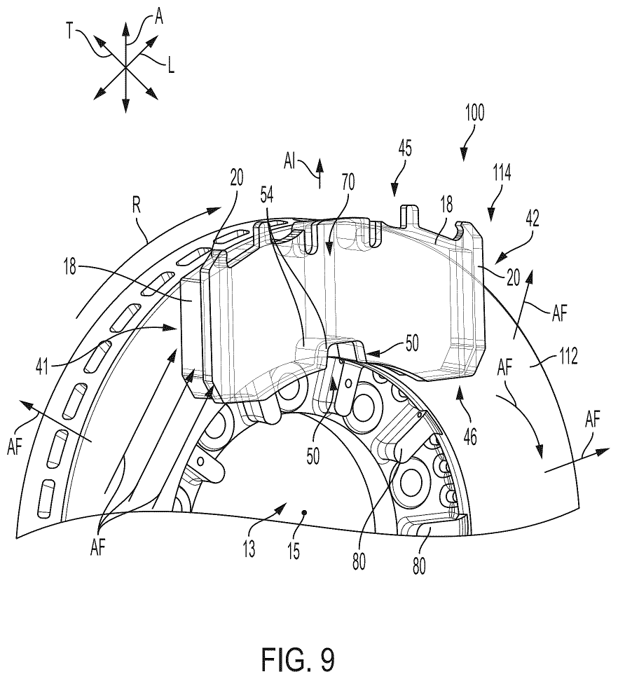

Turning on to FIGS. 9-11, the present inventors discovered that the notch 50 and the channel 70 of the inner brake pad 114 advantageously promote air flow around and/or through the disc brake 100 thereby dissipating heat and/or lowering the operating temperature of one or more components (e.g., the rotor 112, the inner brake pad 114) of the disc brake 101. Note that FIGS. 9-11 depict the inner brake pad 114 as transparent to expose the rotor 112, and the inner backing plate 20 is depicted in front of the inner friction member 18.

During operation of the disc brake 100, the rotor 12 is rotated in a first rotational direction (see rotation arrow R; e.g., clockwise direction) or a second rotational direction (e.g., counterclockwise). Rotation of the disc brake 100 induces air flow (see arrows AF) in the direction of rotation of the rotor 112. The rotor 112 includes raised elements 80 that promote and induce flow of the air in the direction of rotation of the rotor 112 (e.g., in the first rotational direction).

Rotation of the rotor 112 also causes the air to flow radially outwardly from the center hole 13 and center axis 15 of the rotor 112 (see example arrow AF). The present inventors recognized that the air flow could be utilized to cool the rotor 112 and/or the inner brake pad 114. As such, the present inventors designed the notch 50 to collect more air flow such that the inner brake pad 114 facilitates greater cooling of the disc brake 110 in comparison to conventional brake pads and conventional disc brakes. In certain examples, the surfaces of the example brake pads of the present disclosure (e.g., the notch surfaces) advantageously promote and maximize air flow through the notch and/or the channel of the brake pad. In certain examples, the surfaces of the example brake pads of the present disclosure advantageously promote laminar airflow through the channel that is not possible with conventional brake pads having irregular or asymmetrical features. In certain examples, the inner brake pad 114 of the present disclosure increases the volume and/or speed of the air passing through the notch 50 and/or the channel 70 thereby increasing cooling of the disc brake 100.

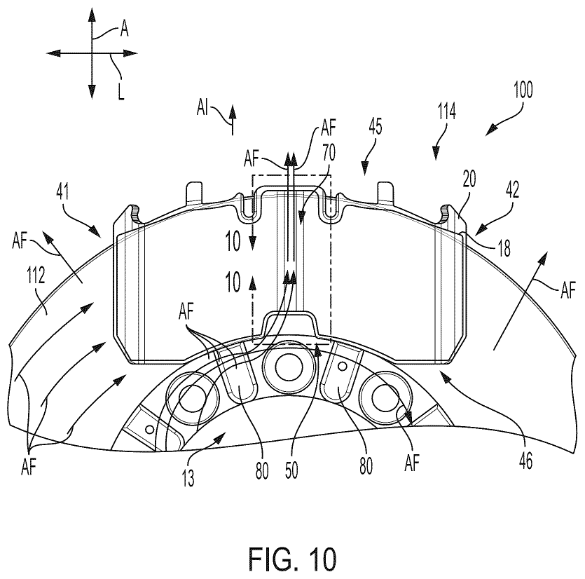

The increased air flow passing through the notches 50 and/or the channel 70 and/or along with the increased widths of the notches 50 and/or the channel 70 also advantageously permits debris (e.g., dust, dirt from the road, debris generated as the inner friction member 18 wears) and/or moisture to carried through the notch 50 and the channel 70. The present inventors recognized that brake dust from worn pads and rotors may collect and accumulate in conventional disc brakes thereby reducing the effectiveness of the conventional disc brakes and increasing brake noise generated by conventional disc brakes. The present inventors designed the inner brake pad 114 with the notch 50 and the channel 70 of the present disclosure to increase air flow to thereby promote the removal of debris and moisture from the disc brake 10. As such, the risk of the disc brake 100 collecting debris is reduced. FIG. 10 depicts an example air flow AF through the notch 50 and the channel 70 with example debris 99 is moved axially and radially outwardly in the first axial direction (arrow A1) and ejected from the channel 70.

In certain examples, conventional brake pads can have several disadvantages such as dust and/or debris becoming packed into the depressions of the conventional brake pads, vibrations are generated, and/or excess heat is generated. Noisy conventional brake pads are an annoyance to the vehicle's operator and typically cause brake-related complaints. Further, conventional brake pads tend to wear faster at elevated temperatures, therefore if the temperature of the brake pads and the rotor of the present disclosure can be minimized, life of the brake pads of the present disclosure are extended in comparison to conventional brake pads. Debris buildup on conventional disc brakes can cause uneven wear across the conventional brake pads and rotors.

In certain examples, a brake pad for a disc brake that brakes a rotor that is rotated about a center axis includes a first side, an opposite second side longitudinally spaced apart from the first side, a first end, and an opposite second end axially spaced apart from the first end. The brake pad includes a backing plate and a friction member on the backing plate with the friction member configured to engage the rotor. A symmetrical notch extends through the backing plate and the friction member and located at the second end. The notch axially extends from the second end toward the first end. A channel axially extends through the friction member between the notch and the first end.

In independent aspects, an axially extending brake pad plane is located equidistant between the first side and the second side and the notch is centered on the brake pad plane. In independent aspects, the notch is symmetric about the brake pad plane. In independent aspects, the channel is notch is centered on the brake pad plane. In independent aspects, the channel is symmetric about the brake pad plane. In independent aspects, the channel is defined by a rounded center surface of the friction member and a pair of side surfaces of the friction member that extend from the center surface. In independent aspects, the pair of side surfaces extend transverse to each other and form a channel angle therebetween. In independent aspects, the notch includes a first notch portion on one side of the brake pad plane and a second notch portion on the other side of the brake pad plane and the shape of the second notch portion is a mirror opposite of the shape of the first notch portion. In independent aspects, the notch has a first notch end that is oriented toward the channel and a second notch end that is configured to be oriented toward the center axis of the rotor and the first notch end is in fluid communication with the channel. In independent aspects, the friction member has end surfaces and a notch surface at least partially defines the notch, the end surfaces extend along the second end, and the notch surface includes a pair of first transition sections adjacent to the end surfaces, a pair of second transition sections axially between the first end and the second end, and a center section located between the second transition sections. In independent aspects, the first transition sections and the second transition sections are configured to direct air flow generated by the rotor axially through the notch and the channel. In independent aspects, the first transition sections and the second transition sections are curved. In independent aspects, an axially extending brake pad plane is located equidistant between the first side and the second side and one of the first transition sections and one of the second transition sections are located on each side of the brake pad plane.

In certain examples, a brake pad for a disc brake that brakes a rotor that is rotated about a center axis, the brake pad a first side, an opposite second side longitudinally spaced apart from the first side, a first end, and an opposite second end axially spaced apart from the first end. The brake pad includes a backing plate and a friction member on the backing plate, the friction member configured to engage the rotor. A symmetrical notch extends through the backing plate and the friction member and is located at the second end. The notch axially extends from the second end toward the first end. A symmetrical channel axially extends through the friction member and is located between the notch and the first end. The notch and the channel are centered between the first end and the second end.

In independent aspects, the friction member has end surfaces and a notch surface that at least partially defines the notch, the end surface extends along the second end, the notch surface includes a pair of first transition sections adjacent to the end surfaces, a pair of second transition sections axially between the first end and the second end, and a center section located between the second transition sections. In independent aspects, the first transition sections and the second transition sections are configured to direct air flow generated by the rotor through the notch and the channel.

In certain examples, a disc brake for braking a rotor that is rotated about a center axis includes a caliper and a brake pad coupled to the caliper. The brake pad is configured to engage the rotor to thereby slow or stop rotation of the rotor about the center axis, and the brake pad includes a first side, an opposite second side longitudinally spaced apart from the first side, a first end, and an opposite second end axially spaced apart from the first end. The brake pad includes a backing plate and a friction member on the backing plate. The friction member is configured to engage the rotor. A symmetrical notch extends through the backing plate and the friction member, is located at the second end, and the notch axially extends from the second end toward the first end. A channel axially extends through the friction member between the notch and the first end.

In independent aspects, the brake pad defines an axially extending brake pad plane that is located equidistant between the first side and the second side and the notch is centered on the brake pad plane. In independent aspects, both the notch and the channel are each symmetric about the brake pad plane. In independent aspects, the notch includes a first notch portion on one side of the brake pad plane and a second notch portion on the other side of the brake pad plane. The shape of the second notch portion is a mirror opposite of the shape of the first notch portion.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A brake pad for a disc brake that brakes a rotor that is rotated about a center axis, the brake pad comprising:
a first side, an opposite second side longitudinally spaced apart from the first side, a first end, and an opposite second end axially spaced apart from the first end;
a backing plate and a friction member on the backing plate, wherein the friction member is configured to engage the rotor;
a symmetrical notch extending through the backing plate and the friction member and located at the second end, the notch axially extending from the second end toward the first end; and
a channel axially extending through the friction member between the notch and the first end.

2. The brake pad according to claim 1, wherein an axially extending brake pad plane is located equidistant between the first side and the second side; and
wherein the notch is centered on the brake pad plane.

3. The brake pad according to claim 2, wherein the notch is symmetric about the brake pad plane.

4. The brake pad according to claim 2, wherein the channel is notch is centered on the brake pad plane.

5. The brake pad according to claim 2 wherein the channel is symmetric about the brake pad plane.

6. The brake pad according to claim 2, wherein the channel is defined by a rounded center surface of the friction member and a pair of side surfaces of the friction member that extend from the center surface.

7. The brake pad according to claim 6, wherein the pair of side surfaces extend transverse to each other and form a channel angle therebetween.

8. The brake pad according to claim 2, wherein the notch includes a first notch portion on one side of the brake pad plane and a second notch portion on the other side of the brake pad plane, and wherein the shape of the second notch portion is a mirror opposite of the shape of the first notch portion.

9. The brake pad according to claim 1, wherein the notch has a first notch end that is oriented toward the channel and a second notch end that is configured to be oriented toward the center axis of the rotor, and wherein the first notch end is in fluid communication with the channel.

10. The brake pad according to claim 1, wherein the friction member has end surfaces and a notch surface at least partially defines the notch, and wherein the end surfaces extend along the second end and the notch surface includes:
a pair of first transition sections adjacent to the end surfaces;
a pair of second transition sections axially between the first end and the second end; and
a center section located between the second transition sections.

11. The brake pad according to claim 10, wherein the first transition sections and the second transition sections are configured to direct air flow generated by the rotor axially through the notch and the channel.

12. The brake pad according to claim 10, wherein the first transition sections and the second transition sections are curved.

13. The brake pad according to claim 10, wherein an axially extending brake pad plane is located equidistant between the first side and the second side;
wherein one of the first transition sections and one of the second transition sections are located on each side of the brake pad plane.

14. A brake pad for a disc brake that brakes a rotor that is rotated about a center axis, the brake pad comprising:
a first side, an opposite second side longitudinally spaced apart from the first side, a first end, and an opposite second end axially spaced apart from the first end;
a backing plate and a friction member on the backing plate, the friction member configured to engage the rotor;
a symmetrical notch extending through the backing plate and the friction member and located at the second end, the notch axially extending from the second end toward the first end;
a symmetrical channel axially extending through the friction member and is located between the notch and the first end;
wherein the notch and the channel are centered between the first end and the second end.

15. The brake pad according to claim 14, wherein the friction member has end surfaces and a notch surface that at least partially defines the notch, and wherein the end surface extends along the second end and the notch surface includes:
a pair of first transition sections adjacent to the end surfaces;
a pair of second transition sections axially between the first end and the second end; and
a center section located between the second transition sections.

16. The brake pad according to claim 15, wherein the first transition sections and the second transition sections are configured to direct air flow generated by the rotor through the notch and the channel.

17. A disc brake for braking a rotor that is rotated about a center axis, the disc brake comprising:
a caliper; and
a brake pad coupled to the caliper and configured to engage the rotor to thereby slow or stop rotation of the rotor about the center axis, the brake pad includes:
a first side, an opposite second side longitudinally spaced apart from the first side, a first end, and an opposite second end axially spaced apart from the first end;
a backing plate and a friction member on the backing plate, the friction member configured to engage the rotor;
a symmetrical notch extending through the backing plate and the friction member and located at the second end, the notch axially extending from the second end toward the first end; and
a channel axially extending through the friction member between the notch and the first end.

18. The disc brake according to claim 17, wherein the brake pad defines an axially extending brake pad plane that is located equidistant between the first side and the second side;
wherein the notch is centered on the brake pad plane.

19. The disc brake according to claim 18, wherein both the notch and the channel are each symmetric about the brake pad plane.

20. The disc brake according to claim 18, wherein the notch includes a first notch portion on one side of the brake pad plane and a second notch portion on the other side of the brake pad plane, and wherein the shape of the second notch portion is a mirror opposite of the shape of the first notch portion.
